(19) United States
(12) Patent Application Publication
(10) Pub. No.: US 2014/0159258 A1
(43) Pub. Date: Jun. 12, 2014

(54) MIXER AERATOR

(71) Applicants: NELS LADOUCEUR, DELTA (CA); PETER JACK, DELTA (CA)

(72) Inventors: NELS LADOUCEUR, DELTA (CA); PETER JACK, DELTA (CA)

(21) Appl. No.: 14/101,261

(22) Filed: Dec. 9, 2013

Related U.S. Application Data
(60) Provisional application No. 61/735,466, filed on Dec. 10, 2012.

(51) Int. Cl. B01F 3/04

(52) U.S. Cl. CPC B01F 3/04531
USPC 261/93

(57) ABSTRACT

A mixer/aerator described herein may characterize in one aspect as includes a parallel spaced apart array of discs mounted on a drive shaft. Each disc includes flow apertures separated by spokes. Each spoke is shaped to induce a fluid flow through a corresponding flow aperture, wherein the flow aperture trails a trailing edge of the spoke relative to the rotational direction of the discs to thereby induce a columnar fluid translation of the fluid through the array of discs while simultaneously driving the fluid laterally radially outwardly relative to the discs. Upper discs urge the corresponding columnar fluid translation downwardly, and lower discs urge the corresponding columnar fluid translation upwardly. At least one annular turbulent-mixing passageway is formed between the upper discs and the lower discs wherein said upward and downward columnar fluid translations of the fluid mix while being forced radially outwardly relative to the discs.

### FIELD OF THE INVENTION

This invention relates to the field of mixing and aerating apparatus wherein at least one shaft-driven rotating member which rotates in a plane which is orthogonal to the shaft is at least partially submerged in a fluid to be mixed or aerated.

### BACKGROUND OF THE INVENTION

In the prior art Applicant is aware of U.S. Pat. No. 6,280,078 which issued Aug. 28, 2001, to Lewis for a Double Sided. Mixing and Aerating Apparatus, incorporated herein by reference, wherein Lewis states that efficient mixing of dissimilar fluids or fluids and solids is required in many situations including chemical processing, sewage treatment, waste water aeration, etc. Lewis states that mixing is typically achieved by rotating blades or impellors that physically displace the fluid thereby causing agitation that leads to mixing.

Lewis states that U.S. Pat. No. 5,344,235 describes an improved impellor blade having an airfoil shape, indicating that the impellor blade is indicative of the state of the art of impellor based mixers and aerators. Lewis also refers to U.S. Pat. No. 4,865,459 as describing a mixer having a rotating disc mounted on a shaft a small distance from a fixed disc, and that a propeller is mounted on the end of the shaft for drawing in liquid which is forced through apertures in the rotating disc to be engaged by shear forces between the fixed and rotating discs to produce mixing. Lewis refers to U.S. Pat. No. 4,267,051 as describing an aerator having a group of parallel plates which are rotated near the surface of the liquid by a horizontal shaft. A rectangular cavity in the periphery of each disc traps air and forces it below the liquid level as the discs rotate.

Lewis describes his own apparatus as including a central disc driven by a rotating shaft wherein a number of mixing plates are stacked above and/or below the central disc, spaced from and parallel to the central disc. Each plate is describes as having a central aperture, where the diameter of the central aperture in each disc becomes increasingly greater for discs which are progressively further from the central disc. The increasing diameter of the central apertures in the discs define a space which is coaxial with the rotating shaft. Lewis describes that, in operation, the fluid is drawn into the spaced defined by the central apertures in the discs and is directed out through the spaces between the plates. Lewis further describes that when the apparatus is placed near the surface of a fluid, air is drawn in and the fluid is aerated as well as mixed.

FIGS. 1a, 1b, and 1c herein, labelled prior art, correspond to FIGS. 4-6 in the Lewis patent and show, respectively, a side cross section view of one embodiment of the Lewis apparatus wherein the spaced defined by the central apertures in the discs diverges upwardly and downwardly from the central plate, a diagrammatic view of the directions of flow of fluid during operation of the Lewis apparatus, and a depiction of the Lewis apparatus in operation.

### SUMMARY OF THE INVENTION

In summary, the mixer/aerator described herein may characterized in one aspect as including a parallel spaced apart array of discs mounted orthogonally onto a drive shaft, the drive shaft rotated in its direction of rotation about a corresponding axis of rotation, wherein the axis of rotation extends longitudinally along the shaft.

Each disc in the array of discs lies in a corresponding plane and includes flow apertures separated by a corresponding radially spaced apart array of spokes. Each spoke is shaped to induce a fluid flow through a corresponding flow aperture, wherein the flow aperture trails a trailing edge of the spoke relative to the rotational direction of the discs to thereby induce a columnar fluid translation of the fluid through the array of discs while simultaneously driving the fluid laterally radially outwardly relative to the discs in the array of discs.

In one embodiment a first number of the discs are upper discs urging the columnar fluid translation downwardly, and a second number are lower discs urging the columnar fluid translation upwardly. At least one annular turbulent-mixing passageway is formed between the upper discs and the lower discs wherein the upward and downward columnar fluid translations of the fluid mix while being forced radially outwardly relative to the discs and the shaft.

In the illustrated embodiment, which is not intended to be limiting, the turbulent mixing passageway is a central passageway and the first and second numbers of the upper and lower discs are substantially equal. That is, the first number of the upper discs is substantially equal to the second number of lower discs. Thus in one embodiment the upper discs contain at least three upper discs, and the second number lower discs contain at least three lower discs.

Preferably the discs have a diameter in the range of substantially four to eight inches, and each disc has at least three spokes, in which case the drive shaft is driven at a speed of rotation in the range of substantially 900-3500 RPM.

In the illustrated embodiments, which are not intended to be limiting, the trailing edge of each spoke is deflected out of the plane of its corresponding disc by a deflection angle to form a flap or tab, or vane, or an airfoil-shape, collectively referred to herein as a vane, and wherein the deflection is in a direction corresponding to the columnar fluid translation of the fluid flowing through the discs' flow apertures. For example the deflection angle may be in the range of substantially 5 to 45 degrees, and in one embodiment the deflection angle is substantially in the range of 10-20 degrees. Preferably each spoke has its corresponding vane, and preferably each disc includes at least three spokes. In other embodiments each disc includes at least four spokes.

In an alternative embodiment the leading edge of each spoke is raked aft relative to the rotational direction of the discs so that a radially outermost end of the leading edge of the spoke trails a radially innermost end of the leading edge of the spoke relative to the rotational direction. The rake of the leading edge of the spoke has a rake angle which may be in the range of substantially 0 to 60 degrees, for example the rake angle maybe substantially 45 degrees.

In a preferred embodiment each disc includes a hub at a radially innermost end of the array of spokes and a substantially planar ring at a radially outermost end of the array of spokes.

Each disc has a diameter measured across the disc at its widest. Each ring has a radial width dimension measured along a radial line from the axis of rotation. In one embodiment the radial width dimension is substantially in the range of 15-25 percent of the diameter of the disc. For example, the radial width dimension of the ring may be substantially 20 percent of the diameter of the disc.

Each spoke has a radial length from the hub to the ring which may be substantially in the range of 15 to 85 percent of the diameter of the disc. For example the radial length of each spoke may be substantially 15 percent of the diameter of the disc.

Each flow aperture sweeps out a radial sector about the axis of rotation. The radial sector may be substantially in the range of 40 to 80 degrees. For example the radial sector may be substantially 60 degrees.

### BRIEF DESCRIPTION OF THE DRAWINGS

FIG. 1a is a copy of FIG. 4 from U.S. Pat. No. 6,280,078.

FIG. 1b is a copy of FIG. 5 from the prior art patent of FIG. 1a.

FIG. 1c is a copy of FIG. 6 from the prior art patent of FIG. 1a.

FIG. 2 is, in side elevation, the mixer/aerator according to one embodiment as described in the present specification.

FIG. 3 is, in plan view, one of the discs of FIG. 2.

FIG. 4 is an enlarged partially cut away sectional view of a portion of FIG. 2.

FIG. 5 is a sectional view along line 5-5 in FIG. 3.

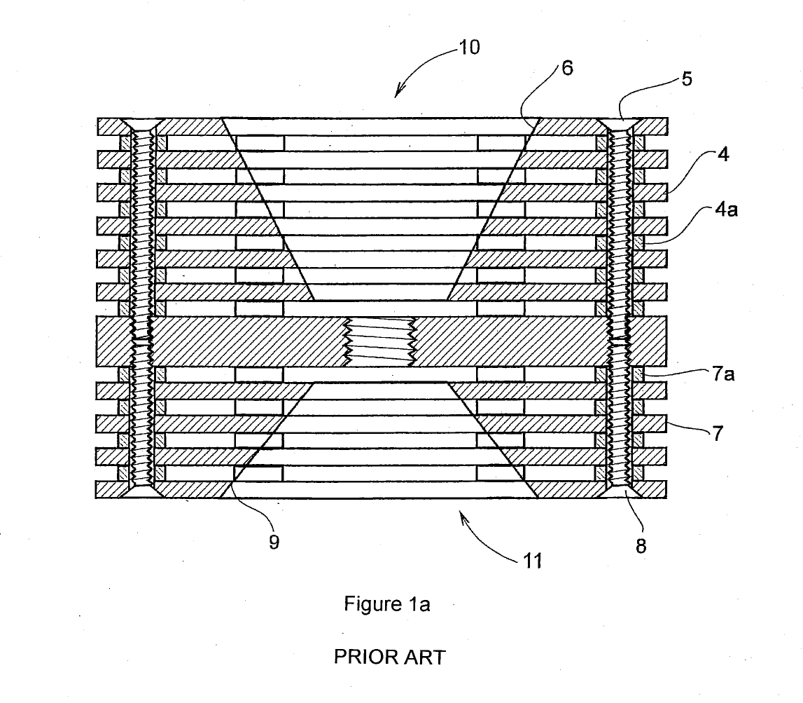

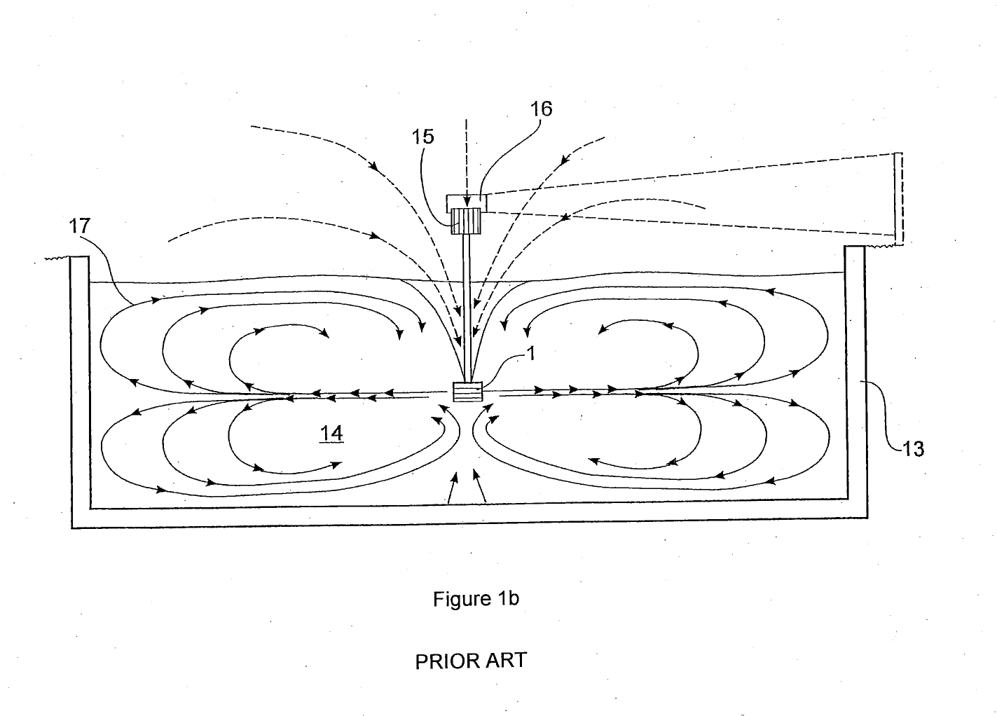

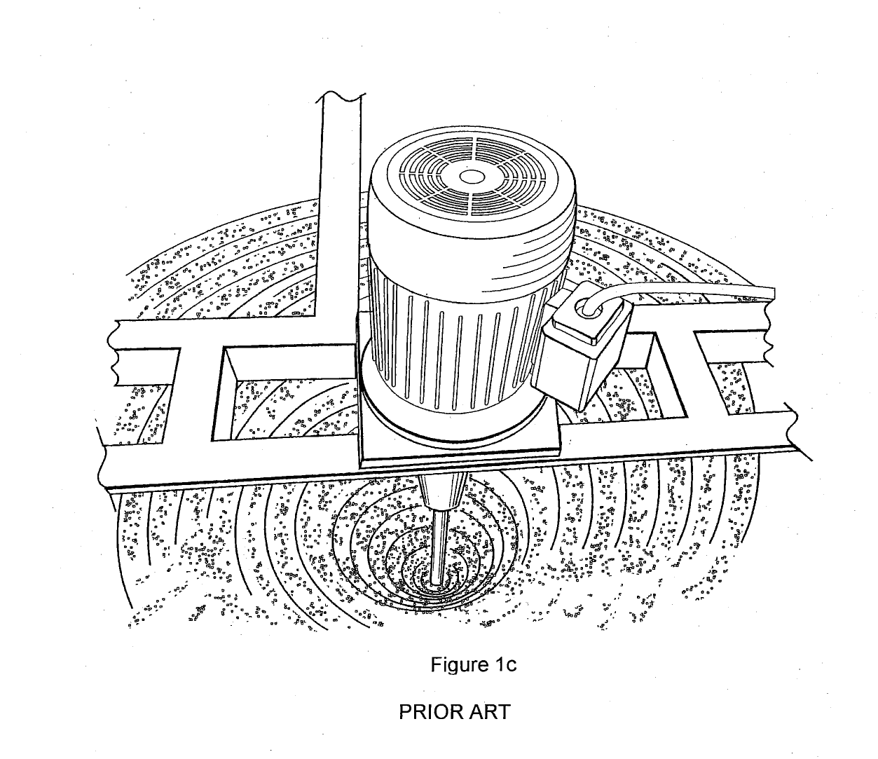

### DETAILED DESCRIPTION OF EMBODIMENTS OF THE INVENTION

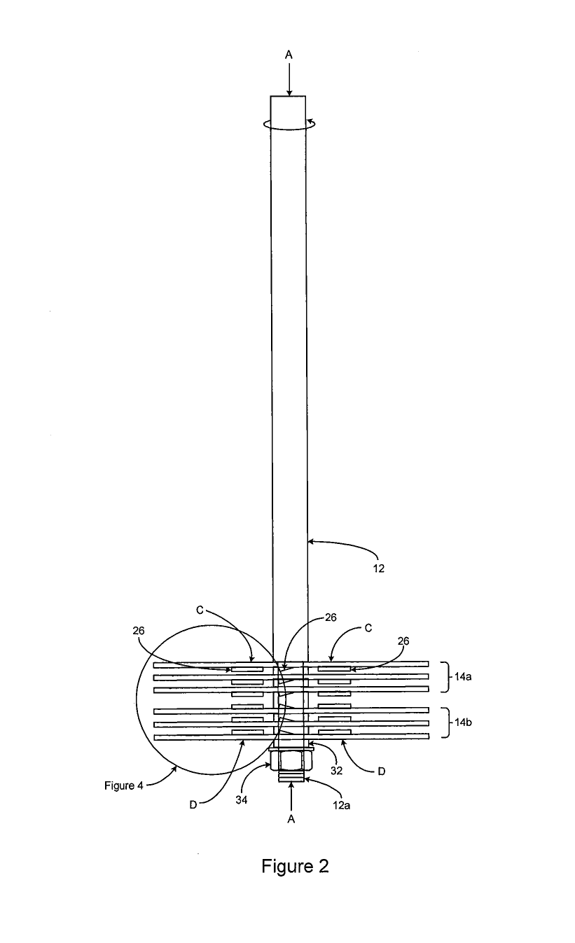

Mixer/aerator 10 includes a driven shaft 12, driven by a motor (not shown). Discs 14 are mounted on the lower end 12a of shaft 12. As seen in FIG. 2, discs 14 are mounted onto shaft 12 in parallel spaced apart array, oriented orthogonally relative to the axis of rotation A of shaft 12.

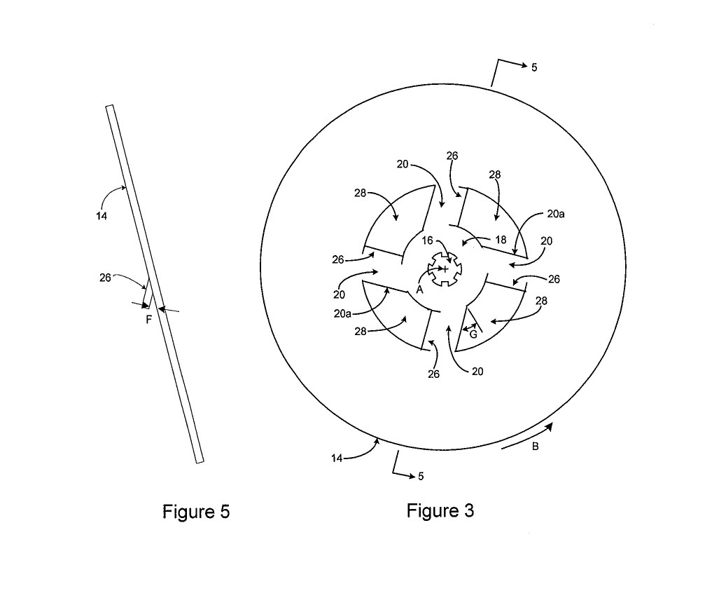

Two different types of discs 14 are employed in the embodiment of FIG. 2; namely, upper discs 14a and lower discs 14b. One upper disc 14a is shown in plan view in FIG. 3. Each disc 14 mounts onto shaft 12 by mounting the correspondingly shaped lower end 12a through central aperture 16 in each disc. Thus in the embodiment of FIG. 2, a snug keyway-type mounting of disc 14 onto lower end 12a of shaft 12 is achieved by journaling lower end 12a through aperture 16 in each of discs 14. Aperture 16 may be a cut out when disc 14 is a thin metal plate. Aperture 16 provides one means for preventing rotation of disc 14 relative to shaft 12. As would be known to one skilled in the art, this may be accomplished by a variety of ways such as for example, by other keyway-type mounting profiles or for example by mating of teeth or other protrusions onto splines or the like on lower end 12b of shaft 12. Collectively the many ways of locking disc 14 onto shaft 12 to prevent rotation of the disc relative to the shaft are referred herein, and without limitation, as disc-to-shaft mating means.

Each disc 14 is preferably substantially circular around its circumferential rim so as to be substantially symmetric about the center of the disc. The center of the disc coincides with where the plane of the disc intersects with axis of rotation A. A hub 18 on each disc contains aperture 16 and supports radial spokes 20. Spokes 20 are mounted to or formed so as to extend between hub 18 and annular planar ring 22. Circumferential rim 24 extends around so as to define the outer edge of ring 22. Hub 18 is concentric with ring 22 relative to axis of rotation A. Spokes 20 support vanes 26 on the trailing edges thereof. Spokes 20 and vanes 26 define flow apertures 28 therebetween. Flow apertures 28 are formed as radial sectors about axis of rotation A.

Thus with shaft 12 and discs 14 rotating in direction B about axis of rotation A, each spoke 20 has a leading edge 20a opposite to its corresponding trailing edge, that is, opposite to its vane 26.

Although applicants do not wish to be bound by any particular theory of operation, vanes 26 may operate in a somewhat similar fashion to flaps found on conventional aircraft wings which induce a lowered pressure in the fluid flowing over the upper cambered surface of the airfoil and flap. Thus when the disc 14 illustrated in FIG. 3 is an upper disc 14a, so that surface of 22a of flange 22 is the upper surface of the disc, vanes 26 are downturned such as seen in FIG. 5. Thus with discs 14 submerged within a fluid, rotation of discs 14 in direction B induces downward flow in direction C of the fluid passing over spokes 20 and vanes 26 so as to flow downwardly through flow apertures 28. If flow apertures are aligned one over another in the stack of discs 14a, then the result will be a fluid flow downwardly as a column (relative to the discs), herein referred to as a columnar fluid translation.

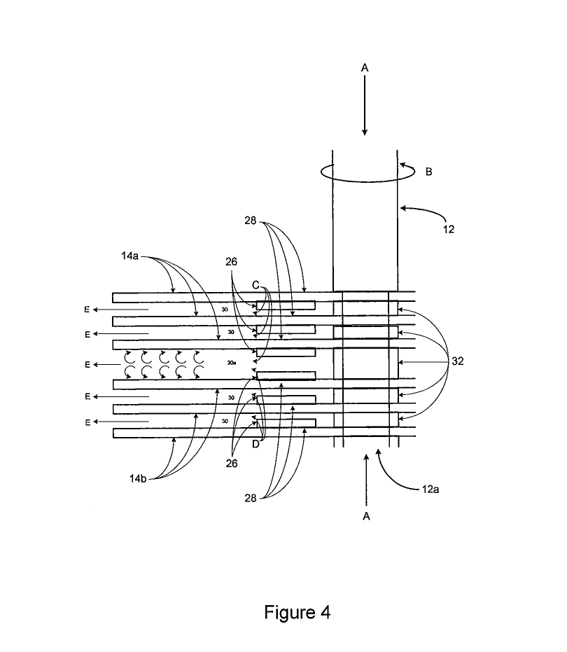

Conversely, if disc 14 in FIG. 3 is a view of the upper side of a lower disc 14b then vanes 26 are deflected upwardly relative to the surface of lower disc 14b. This urges fluid upwardly through flow apertures 28 in direction D, better seen in FIG. 4, as lower discs 14b on shaft 12 rotate in direction B. This also causes a columnar fluid translation, in this case upwardly, through flow apertures 28 in the stack of lower discs 14b.

As seen in the section view of FIG. 4, the fluid flow through flow apertures 28 downwardly in direction C and upwardly in direction D are redirected from their direction of flow entering into the first apertures 28 so as to flow radially laterally outwardly in directions E relative to axis of rotation A. The radially outwardly lateral flows in direction E pass through annular passages 30 formed between adjacent discs 14. The downward and upward flows in directions C and D respectively collide and intermingle so as to turbulently mix in central annular passageway 30a before also exiting radially outwardly from passageway 30a in direction E′. The spacing between adjacent discs 14 may be regulated by spacers 32. The discs and spaces may be secured onto lower end 12a of shaft 12 for example by the threaded mounting of nut 34 onto the corresponding threaded end of shaft 12.

In one embodiment, discs 14 are six inches in diameter, although other disc diameters would work, for example, and without intending to be limiting, four inch or eight inch diameters. Each disc 14 may be steel plate for example, stainless steel having a thickness of approximately one to two millimetres. Shaft 12 may for example be one inch in diameter and lower end 12a may be approximately % inch in diameter, although again the cross sectional profile of lower end 12a will vary depending on the type of disc-to-shaft mounting means employed.

Fewer or greater number of discs 14 may be employed depending on the application and depending on the length of the lower end 12a of shaft 12 and the spacing between discs 14 provided by spacers 32. In a preferred embodiment at least three discs 14 are employed for each of upper discs 14a and lower discs 14b. Because discs 14 are removably mounted onto lower end 12a, depending on the application, where the additional mixing provided within central aperture 30a is either not required or not desired, it may be that all of the discs 14 in the parallel array of discs are either upper discs 14a if a downwardly directed flow though flow apertures 28 is desired, or all may be lower discs 14b if an upwardly directed flow through flow apertures 28 is desired. In such cases, a downward or upward flow through apertures 28 respectively would form a moving column of fluid for example if flow apertures 28 in each adjacent plate 14 were aligned with one directly above another, or if flow apertures 28 were offset from one another for example offset rearwardly relative to the direction B of rotation of the discs, in which case the column of fluid moving through flow apertures 28 (the columnar flow fluid translation) may flow along a curved path, for example, forming a segment of a helix relative to the discs.

Advantageously, vanes 26 are angled out of the plane of each corresponding disc 14 by angle F. Angle F may for example be approximately 15 degrees although other angles would work as would be known to one skilled in the art. Again, without intending to be bound by any particular theory of operation, the deflection of vanes 26 may also be accomplished by a relatively smooth curved surface over spoke 20 smoothly blending into an out-of-plane flap or flange or other deflected member so as to smoothly urge the flow of fluid thorough the corresponding aperture 28 without inducing inordinate (or any) flow separation.

In one preferred embodiment, up to twelve discs 14 may be employed on each shaft 12 wherein some proportion of the number of discs 14, for example one half, are upper discs 14a and the remaining discs are lower discs 14b. It will be understood by one skilled in the art that the upper discs 14a may be employed for aeration, in particular if the uppermost upper disc 14a is maintained adjacent the nominal surface of the fluid while the discs are submerged. For example, air will be drawn down into the uppermost disc 14a when the uppermost disc is spaced from the nominal surface of the fluid by for example up to three inches, although this will vary depending on the type of fluid, size of the discs, speed of rotation, etc. However, in experiments successfully conducted using five inch diameter discs 14, aeration occurred in the range of zero to three inches of depth of the uppermost disc 14a beneath the nominal surface of the fluid when the discs were rotated at approximately 3000 RPM about axis A.

As also will be appreciated by one skilled in the art, the aerating discs 14a and the lower discs 14b will in combination accomplish mixing of the fluid, especially in the embodiment where the upper and lower discs form center passageway 30a. The spacing between discs 14 so as to form passages 30 may be approximately 3/16 of an inch. The spacing between the center-most discs so as to form center passageway 30a may be approximately ⅜ of an inch, although these dimensions are not intended to be limiting.

The size, that is, the length and width of spokes 20 will vary depending on the application, for example depending on the type of fluid being mixed and/or aerated. Deflection angle F of vanes 26 means that leading edges 20a on upper discs 14a are higher than the trailing edges of vanes 26, and that the leading edges 20a on lower discs 14b are lower than the trailing edges of the corresponding vanes 26. Thus, the flow laterally outwardly in directions E from passages 30 is due to centrifugal force and the laterally outward flow from central passageway 30a in direction E′ may be due to both centrifugal force and due to the pressure created by the flows in directions C and D being urged into passageway 30a.

In one embodiment, such as illustrated in FIG. 3, centrifugal flow in direction E may be enhanced while maintaining the axial flows in directions C and D when the leading edges 20a of spokes 20 are raked relative to the direction of rotation, for example, raked by angle G. Angle G may be for example in the order of 45 degrees, although this is not intended to be limiting.

Although not illustrated, as mentioned above, discs 14 may be angularly offset about axis A relative to each other, for example, offset by 15-30 degrees between adjacent discs although this is not intended to be limiting, depending on the application and the type of fluid being mixed and/or aerated. Rotation speeds of disc 14 about axis A may be substantially in the range of 900-3500 RPM depending on the size of the discs and the application. Mixer/aerator 10 may be mounted on various types of platforms or float systems that may employed to set the desired operating depth of discs.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A mixer/aerator comprising:
a drive shaft for rotation about a corresponding axis of rotation in a rotational direction, said axis of rotation extending longitudinally along said shaft,
a parallel spaced apart array of discs mounted orthogonally onto said shaft,
wherein each disc of said array of discs lies in a corresponding plane and includes apertures separated by a corresponding radially spaced apart array of spokes,
and wherein substantially each spoke of said array of spokes is shaped to induce a fluid flow through a corresponding said flow aperture, wherein said aperture trails a trailing edge of said spoke relative to said rotational direction to thereby induce a columnar fluid translation of said fluid through said array of discs while simultaneously driving said fluid laterally radially outwardly relative to said discs in said array of discs.

2. The mixer/aerator of claim 1 wherein a first number of said discs in said array of discs are upper discs urging said columnar fluid translation downwardly, and a second number are lower discs urging said columnar fluid translation upwardly, and wherein at least one annular turbulent mixing passageway is formed between said upper discs and said lower discs, wherein said upward and downward columnar fluid translation of said fluid mix while being forced said radially outwardly relative to said discs and said shaft.

3. The mixer/aerator of claim 2 wherein said at least one turbulent mixing passageway is a central passageway and said first and second numbers of said upper and lower discs are substantially equal.

4. The mixer/aerator of claim 2 wherein said first number of said upper discs is substantially equal to said second number of lower discs.

5. The mixer/aerator of claim 3 wherein said first number of said upper discs contains at least three said upper discs, and said second number of said lower discs contains at least three said lower discs.

6. The mixer/aerator of claim 5 wherein said discs having a diameter in the range of substantially four to eight inches, and each said disc has at least three said spokes.

7. The mixer/aerator of claim 6 wherein said drive shaft is driven at a speed of rotation in the range of substantially 900-3500 RPM.

8. The mixer/aerator of claim 1 wherein said trailing edge of said spoke is deflected out of said plane by a deflection angle to form one of the group comprising: a flap, a tab, a vane, an airfoil-shape,
and wherein said deflection is in a direction of said columnar fluid translation.

9. The mixer/aerator of claim 8 wherein said deflection angle is in the range of substantially 5 to 45 degrees.

10. The mixer/aerator of claim 9 wherein said array of spokes includes at least three spokes.

11. The mixer/aerator of claim 9 wherein said array of spokes includes at least four spokes.

12. The mixer/aerator of claim 9 wherein said deflection angle is substantially in the range of 10-20 degrees.

13. The mixer/aerator of claim 9 wherein a leading edge of said spoke is raked aft relative to said rotational direction so that a radially outermost end of said leading edge of said spoke trails a radially innermost end of said leading edge of said spoke relative to said rotational direction.

14. The mixer/aerator of claim 13 wherein said rake of said leading edge of said spoke is a rake angle in the range of substantially 0 to 60 degrees.

15. The mixer/aerator of claim 14 wherein said rake angle is substantially 45 degrees.

16. The mixer/aerator of claim 9 wherein said disc includes a hub at a radially innermost end of said array of spokes and a substantially planar ring at a radially outermost end of said array of spokes.

17. The mixer/aerator of claim 16 wherein said disc has a diameter measured across said circumferential rim at its widest and wherein said ring has a radial width dimension measured along a radial from said axis of rotation, and wherein said radial width dimension is substantially in the range of 15-25 percent of said diameter of said disc.

18. The mixer/aerator of claim 17 wherein said radial width dimension is substantially 20 percent of said diameter of said disc.

19. The mixer/aerator of claim 17 wherein each said spoke of said array of spokes has a radial length from said hub to said ring, and wherein said radial length is substantially in the range of 15 to 85 percent of said diameter of said disc.

20. The mixer/aerator of claim 19 wherein said radial length is substantially 15 percent of said diameter of said disc.

21. The mixer/aerator of claim 9 wherein each said aperture sweeps out a radial sector about said axis of rotation of substantially in the range of 40 to 80 degrees.

22. The mixer/aerator of claim 21 wherein said radial sector is substantially 60 degrees.
